(19) United States
(12) Patent Application Publication
(10) Pub. No.: US 2023/0364636 A1
(43) Pub. Date: Nov. 16, 2023

(54) Mixing and Dispensing Syringe for Reactive Systems

(71) Applicant: Charles Albert Rudisill, Apex, NC (US)

(72) Inventor: Charles Albert Rudisill, Apex, NC (US)

(21) Appl. No.: 18/316,424

(22) Filed: May 12, 2023

Related U.S. Application Data
(60) Provisional application No. 63/341,599, filed on May 13, 2022.

(51) Int. Cl. B05C 17/005

(52) U.S. Cl. CPC B05C 17/00593; B05C 17/00506; B05C 17/0052

(57) ABSTRACT

A mixing and dispensing syringe comprising a plunger, barrel and dispensing cap is disclosed. The barrel and plunger are assembled to form a shallow open container for adding reactive components and manually mixing them with a stirring paddle. The relatively wide-open top of the mixing container is proximate the dispensing end of the syringe. After mixing, the dispenser cap is attached to the open end of the barrel preferably with an interference fit. The barrel diameter is preferably comparable to the barrel length. A stop may be provided to prevent relative movement of the barrel and plunger in one or more directions. Although the syringe is designed for mixing reactive hardening components in the syringe, the ease of filling the syringe through the proximal orifice makes it useful for dispensing other materials.

### CROSS-REFERENCE TO RELATED APPLICATIONS

This disclosure claims priority to U.S. provisional patent application No. 63/341,599, filed on May 13, 2022, which is incorporated herein by reference in its entirety.

### BACKGROUND OF THE INVENTION

Dispensing syringes are used in manufacturing, trades and hobby applications to dispense materials in controlled amounts at specific locations. These generally comprise a barrel for holding the material to be dispensed from an orifice or tip that is smaller than the barrel cross-section, a plunger to push the material out of the barrel and a provision to add a smaller orifice needle or nozzle to the tip or hub to further reduce the dispensing flow area. In some cases, the syringes can be pre-filled with the material to be dispensed by the manufacturer of the dispensed material. In other cases, the syringe can be readily filled by the user by partially withdrawing the plunger to create a vacuum to pull in the material through the dispensing orifice. Hypodermic syringes for medicine are familiar examples of pre-filled or readily field-fillable syringes. The low viscosity of typical injectable medicines simplifies this process and the exclusion of entrapped air after filling.

Pre-filled dispensing syringes for liquid reactive compounds such as epoxies are also known. These epoxy systems typically employ adjacent barrels for each element that are dispensed simultaneously with linked plungers. In some cases, the two components are dispensed into a shallow bowl or plate for manual mixing with a stirring paddle. In other cases, a mixing nozzle with a circuitous path may be used. As the elements are forced down the circuitous path, they are combined and exit through a final aperture for application where needed. The length and shape of the path is tailored to provide adequate mixing. Of course, the convenience of mixing in this manner comes at extra cost. This cost comes from the mixing nozzle and at least the wasted material remaining in the mixing nozzle if not the entire supply of the two compounds through backwards cross-contamination. Of course, the mixing nozzle is necessarily single use for most chemical mixtures, and the mixed material must be dispensed before hardening in the nozzle. If the material is dispensed into a bowl for manual mixing, a smaller amount of epoxy can be mixed to avoid some of this waste. This reactive mixture can be put into a dispensing syringe barrel with the mixing paddle, but this is often a messy process that must be done quickly because of the limited working time and increasing viscosity of the combined mixture. Even if only a small amount of material is needed to be dispensed, the transfer process difficulty makes it easier to mix a larger quantity and put it into a larger volume syringe. The viscosity makes it impractical to pull the mixed epoxy into a conventional disposable dispensing syringe, so the mixed epoxy must be loaded into the distal end of the barrel with the mixing paddle or syringe after removing the plunger. This often results in epoxy coming in contact with the user's fingers when dispensing.

In some medical and dental applications, a powder needs to be mixed with a liquid catalyst or solvent to create an adhesive or molding material. A common procedure in dental restoration is to mix a powdered acrylic monomer with a liquid catalyst in a small mixing cup, to transfer this quick-setting acrylic into a large syringe, and then to dispense this into the restoration. This process is time-consuming, wasteful in material mixed but not dispensed, dispenser size and stressful due to the need for speed for all steps after the two precursors mix. This stress is exacerbated with rapid setting systems.

Trying to use a conventional dispensing syringe barrel with the plunger removed as a mixing container to eliminate the transfer is unsatisfactory for several reasons. Conventional syringes have an aspect ratio that makes manipulation of a paddle for manual mixing difficult. Monitoring the mixing at the tip end of the barrel is hidden by the bulk of the material in the barrel. In addition, the transition to a smaller orifice at the tip end leads to inadequate or no mixing. The inadequately mixed material proximate the tip is the first material to be dispensed when the plunger is inserted. These issues are further complicated when there is a powder component. Even if perfectly mixed, inserting the plunger can result in pressure surges from trapped air in the barrel dispensing material uncontrollably. The higher viscosity of hardening mixtures exacerbates this problem. Entrapped air in low viscosity solutions can quickly and easily be cleared from conventional syringes with gravitational forces by reorienting the syringe tip upwards. Too much precious time may be wasted trying to do this with reactive mixtures that flow slowly.

More complicated multi-component mixing and dispensing syringes are known in medical and other technical fields with combinations of valves, metering systems, integral paddles, vacuum pumps to eliminate air or remove noxious reaction byproducts, etc. Many applications do not warrant the expense or complexity of these systems.

To address one or more of the above challenges and limitations of the current mixing and syringe dispensing processes especially for limited working time hardening systems in the dental, medical, industrial, hobby and home repair fields, new mixing syringe embodiments are described herein. These inventive concepts for a dispensing syringe save time, improve mixing efficiency and reduce mess in many applications by allowing effective mixing directly in the syringe barrel thereby eliminating the transfer process. Air in the barrel above the mixture is easily eliminated even with viscous mixtures. A dispensing syringe for hardening mixtures generally has at least a disposable nozzle that has hardened material insider after dispensing. Depending upon the materials, removing these disposable elements to retain unmixed materials or reuse some of the dispensing syringe hardware increases the potential for a mess and takes time and effort. The simplicity of the embodiments disclosed herein allow the entire mixing and dispensing syringe to be inexpensively manufactured and readily disposable. Eliminating the transfer process, the waste of hardening material in an extended mixing nozzle and better mixing control before dispensing can also reduce the amount of excess mixture prepared using the inventive concepts disclosed. The amount of material to be mixed can be readily controlled by weight or volume. All of these features can reduce user stress by improved material control, increasing the effective working time of the mixture and dispensing material accurately only where desired.

### SUMMARY OF THE INVENTION

Some embodiments of the mixing and dispensing syringe in this disclosure include a barrel, plunger and dispensing cap. After inserting the plunger in one end of the barrel, reactive components may be added to the other end of the barrel and manually mixed with a stirring paddle with the plunger acting as the equivalent of the bottom of a mixing cup. After mixing, a dispensing cap is placed over the open end of the barrel. Pressure applied to the plunger against the dispensing cap causes material in the barrel to flow out of an orifice of the dispensing cap.

Some embodiments have a syringe barrel structure that has a shape that is relatively short and wide compared to typical syringe length to diameter aspect ratios. There are several benefits from this aspect ratio in these embodiments for hardening mixtures. Hardening mixtures will necessarily be characterized by an increase in viscosity during the hardening process. Many hardening mixtures have initial dynamic and kinematic viscosities that are orders of magnitude greater than that of water. From Poiseuille's law for resistance, the resistance to flow in a pipe is proportional to the length and inversely proportional to the fourth power of its radius. Since the dispensing nozzle orifice will typically be much smaller than the barrel diameter, improved flow in the barrel alone will generally not provide a major benefit. The major benefit of a short and wide barrel results from easier filling and manual mixing. Hardening mixtures are typically mixed in a shallow dish or even on a flat surface. Having a shallow depth makes it easier to visually monitor the manual mixing process and judge when materials are adequately mixed. The mixing process can also be more efficient since a wider stirring paddle can be used at a wider range of angles perpendicular to the bottom of the pan. For the same volume of material, a wider barrel will have less wall surface than a longer barrel. The portion near the wall of a barrel is the portion that may have less well mixed material than the center of the barrel. The additional surface area of the bottom of the barrel is not important since it is the last material that is dispensed from the barrel in the embodiments disclosed herein and is often never dispensed. This is the opposite of mixing in a conventional syringe where the bottom of the equivalent mixing container is the nozzle end. For many applications, the total volume of hardening material needed to be manually mixed and dispensed will be measured in tens of ml, not hundreds of ml. This volume range can be ergonomically mixed in a relatively short and wide syringe and readily dispensed with the embodiments disclosed using the fingers and thumb of one hand. A wider mixing barrel is easier to fill with powder or liquid components in preparation for mixing in this range of volume.

In some embodiments, the dispensing cap has features to make it easier to use the dispensing syringe with one hand with one or more fingers on the dispensing cap and the thumb on the plunger. In some embodiments, the dispensing cap is preferentially sealed to the barrel simply with an interference fit maintained by the force between the one or more fingers and the thumb during dispensing. The dispensing cap could optionally be sealed to the barrel with a snap fitting or threaded engagement, but this will generally increase part molding complexity and the likelihood of mixed materials contaminating the user's fingers. In some embodiments, the dispensing cap has an extended length surrounding the barrel to contain any material that leaks through the seal with the barrel or was scraped from the stirring paddle. In some embodiments, the dispensing cap includes an integral nozzle. In some embodiments, the dispensing cap includes features to attach a separate nozzle.

In some embodiments, relative movement of the plunger and barrel is prevented by engaging a mechanical lock to facilitate mixing or prevent dispensing. In some embodiments, the distal end of the plunger is shaped to act as a stand during mixing. In some embodiments, relative movement of the plunger and barrel is prevented with a stand that holds the barrel a desired distance above the distal end of the plunger with the plunger resting on a tabletop or a portion of the stand. In some embodiments, the locking position can be adjusted to provide a shallower mixing chamber for mixing a smaller volume of material.

In some embodiments, the plunger includes a separate sealing member to form a seal with the interior wall of the barrel. In some embodiments, the plunger seal is an integrally molded portion of the plunger. In some embodiments, the proximal end of the plunger is flat or concave to facilitate mixing. In some embodiments, the proximal end of the plunger is convex to facilitate dispensing more material with a dispensing cap with a complimentary profile as it narrows to a nozzle. In some embodiments, the plunger seal changes shape when it contacts the dispensing cap to facilitate dispensing more material from the barrel.

In some embodiments, a processing chamber is formed by the barrel and the plunger in which the bottom of the processing chamber is the plunger. Sliding the plunger in the barrel may be used to change the depth of the processing chamber and as a result change the volume of the processing chamber. The volume of the processing chamber may be changed to facilitate different processes. In some embodiments, the processing chamber is used for mixing. In some embodiments, the processing chamber comprises a container for filling with a material for dispensing without mixing.

In some embodiments, the processing chamber acts as a storage chamber that may be filled with one or more reactive materials that are separated to prevent reaction. In some embodiments, one material is trapped in the barrel with a removable seal on the proximal end. This seal may be in the form of a laminar sheet bonded across the opening or a cap or plug that is mechanically attached at the proximal end of the barrel. In some embodiments, a reactive liquid is contained in a packet that may be attached to the distal end of the barrel. Moving the plunger may be used to squeeze the liquid from the packet to allow contact with a second material. In some embodiments, the plunger is moved past the packet to exclude it from a mixing chamber portion of the barrel prior to mixing.

For the purposes of this disclosure, a “viscous material” is a material that has a viscosity greater than glycerin. Some reactive mixtures exhibit increasing viscosity over relatively short time periods as a desirable feature. This characteristic will be referred to as a “reactive hardening”. Other materials have increasing viscosity that results from a transition from a fluid to solid state with cooling. Many of the embodiments discussed are well suited for mixing reactive hardening systems and then dispensing these viscous materials during the hardening process. However, the embodiments may also be applied to mixing and/or dispensing other materials and are considered to be disclosed and within the scope of the claims unless specifically restricted.

For the purposes of this disclosure, the term “squat” should be interpreted as a characteristic of an element in which the height is less than about five times its width. In this disclosure, a squat cylinder should be interpreted as a cylinder in which the cylinder length is less than about five times the diameter of the cylinder. For the purposes of this disclosure, the term “stubby” should be interpreted as a characteristic of an element in which the height is less than about 2 times its width. In this disclosure, a stubby cylinder should be interpreted as a cylinder in which the cylinder length is less than about two times the diameter of the cylinder. Thus, stubby cylinders are a subset of squat cylinders. In addition to ratios of dimensions, for practical or ergonomic reasons, the size of some elements have minimum sizes for gaining a benefit. Where appropriate these guidelines will be provided but are not to be read into the claims unless specifically restricted. For the purposes of this disclosure, a “shallow concave surface” and “shallow convex surface” should be interpreted as concave and convex surfaces that do not deviate from a planar surface by more than ⅓ of the width of the surface.

Elements disclosed herein may be characterized as having a length, width, and often a longitudinal axis. In the case of a long cylindrical object like a pencil, the longitudinal axis is unambiguously through the center of the cylinder from the writing end to the eraser end of the pencil. The longitudinal axis is traditionally considered to be along the length or longest dimension of an object characterized by length, width and thickness in descending dimensional magnitude. In this disclosure, many elements include cylindrical shapes characterized by axial symmetry and described as having a length and a diameter. For a cylinder the length will be measured along the longitudinal axis of symmetry. The cylinder's diameter may also be called the width. Widths will be measured perpendicular to the rotational axis even if this is the longest dimension. Thus, the width of a cylinder herein can be greater than its length. For the purposes of this disclosure, a linear assembly of components results from having the component axes of the assembly in a roughly colinear arrangement. Thus, an assembly comprising a bolt with a washer and nut would be a linear assembly even if the axis of the washer can move around the shared axes of the bolt and nut due to the washer aperture being larger than the width of the threaded section of the bolt. For non-cylindrical objects that are assembled into a dispensing system with a plunger in this disclosure, the longitudinal axis will be parallel to the movement of the plunger. The length will be measured in the longitudinal direction. The width in this case will be the largest dimension perpendicular to the length direction. For the purposes of this disclosure, the term “bore” is used generally to define a channel through something that does not require it to be formed with rotary symmetry or have the same shape or dimensions through the entire channel length. For the purposes of this disclosure, elements may be described as having a proximal end and an opposite distal end. The proximal end should be interpreted to be the end closer to the point of dispensing, that is, the proximal end of a syringe is the nozzle end. The distal end is the end closer to the plunger end of a syringe.

Other terms in the specification and claims of this application should be interpreted using generally accepted, common meanings qualified by any contextual language where they are used. The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The terms “about” and “essentially” mean±10 percent. The term “on the order of” when applied to a dimensional comparison should be interpreted as a relative size ratio of the larger to the smaller that does not exceed about 5:1. Thus a squat cylinder as used herein has a length on the order of its diameter. The term “comparable to” when applied to a dimensional comparison should be interpreted as a relative size ratio of the larger to the smaller that does not exceed about 2:1.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation. The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting. Other objects, features, embodiments and/or advantages of the invention will be apparent from the following specification taken in conjunction with the following drawings.

### BRIEF DESCRIPTION OF DRAWINGS

FIG. 1 is a top exploded isometric view of an embodiment of a mixing and dispensing syringe.

FIG. 2 is a top isometric view of an alternate embodiment of a plunger compatible with the embodiment of FIG. 1.

FIG. 3 is a side plan view of the assembled embodiment of FIG. 1.

FIG. 4 is a side cross-sectional view of the assembled embodiment of FIG. 3.

FIG. 5 is a top isometric view of the assembly of FIG. 3.

FIG. 6 is a bottom isometric view of the assembly of FIG. 3.

FIG. 7 is a top partially assembled isometric view of the assembly of FIG. 3 with an empty processing chamber.

FIG. 8 is a top isometric view of the processing chamber of FIG. 7 during mixing.

FIG. 9 is a top isometric view of the assembly of FIG. 7 after mixing.

FIG. 10 is a top isometric view of the assembly of FIG. 10 prepared for dispensing.

FIG. 11 is a bottom isometric view of the assembly of FIG. 11 dispensing material.

### DETAILED DESCRIPTION OF THE INVENTION

Alternate embodiments of the mixing and dispensing syringe are included in this disclosure. FIG. 1 illustrates one embodiment of the syringe 100 comprising barrel 1, dispensing cap 2, plunger 3 and key 9. Barrel 1 is preferentially a cylinder with a circular bore 20 to simplify sealing, but other shapes may be used for the barrel and bore. Plunger 3 includes a sealing portion 4 which is sized to fit the barrel bore 20 to force material contained inside the bore 20 along the axis of the barrel 1 as the plunger 3 moves axially with respect to the barrel 1 in a direction from the distal end of the barrel towards the proximal end of the barrel. The proximal end of the barrel 1 is shaped to fit inside dispensing cap 2. The distal end of plunger 3 shown includes a base 6 which may be used to stand plunger 3 on a flat surface for filling and mixing material in the syringe as will be explained later. For stability as a stand, base 6 is preferentially larger than the barrel diameter and the syringe is at least squat. Base 6 could incorporate other features to improve stability as a stand including suction cups, magnets, adhesives, high-friction materials or features that interlock with an additional accessory base plate. Base 6 may also be used to apply a force to cause the plunger to move inside the barrel during dispensing.

The body portion 5 of the plunger is found between the proximal end with the sealing portion 4 and the distal end with base 6. The proximal portion of the plunger 6 may include a separate elastomeric sealing cap 4 as shown or O-rings (not shown) for sealing with the bore. Sealing between these parts may also be accomplished by including ribs 12 which may be integrally molded as part of the plunger in addition to or as an alternative to an elastomeric seal. Depending upon the degree of interference fit, ribs 12 may allow some leakage compared to elastomeric seals during dispensing. However, in many applications with more viscous materials this may be an acceptable alternative to save expense. Any leakage may be acceptable if it is completely retained inside the syringe assembly and does not come in contact with the user during dispensing in cases where excess material is not dispensed.

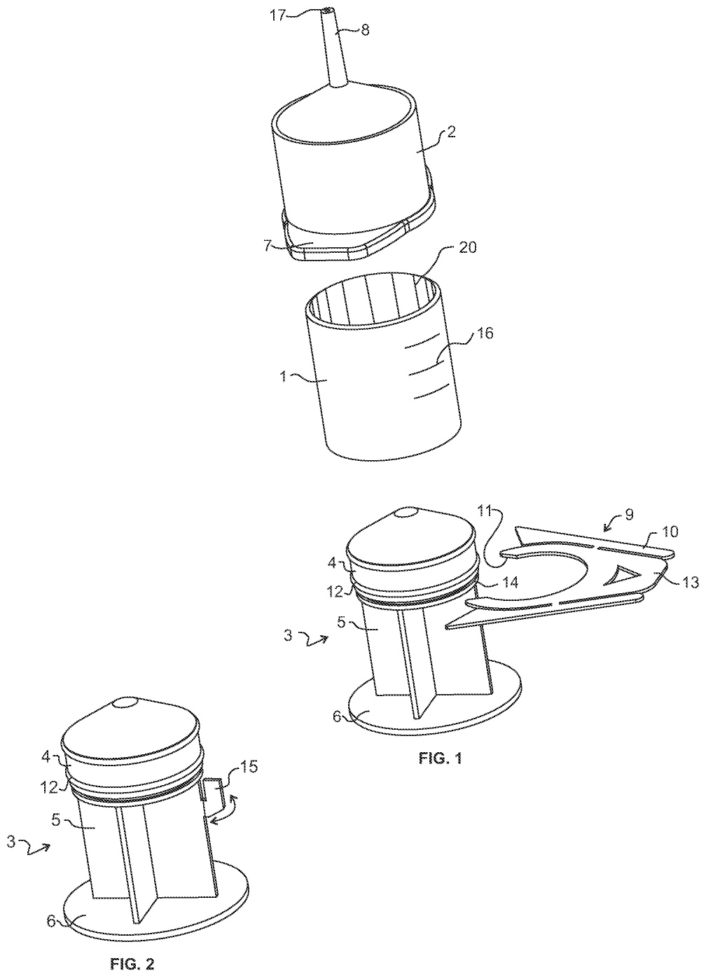

Plunger body 5 illustrated also includes a stop 14 in the form of a grooved flange. Inserting a key 9 into the stop 14 prevents movement of the plunger 3 inside the barrel 1 in the proximal direction. Key 9 as illustrated acts as a support that prevents barrel 1 from moving in a distal direction towards the base 6 of the plunger. Key 9 and barrel 1 may also include an optional locking interface (not illustrated) such as a pin in the key 9 engaging a recess in the barrel 1 that would prevent relative motion of the plunger and barrel in both directions. The key 9 illustrated includes a spring clip feature 11 that snaps into the grooved stop 14. FIG. 2 illustrates an alternate stop 15 in the form of a bendable tab to prevent the barrel 1 from moving past the stop 15 towards the base 6. In order to allow relative movement for dispensing, tab stop 15 would be bent in one of the directions illustrated by arrows until it fit inside the barrel bore 20. Alternatively, tab stop 15 may be removed by other means such as flexing back and forth until material fatigue causes separation of the tab stop 15 from the plunger body 5. There are other known means for preventing relative linear motion of a tube surrounding a cylinder such as a key in the form of a pin inserted in aligned holes of two parts, rotational keying of a pin in a groove, stacking one or more rigid spacer elements between members, placing the cylinder vertically inside a bore that is smaller than the pipe, axially moving spring members, etc. Any of these means may be employed to temporarily prevent relative motion of the plunger 3 and the barrel 1 in at least one direction in combination with one or more of the inventive concepts disclosed herein.

Barrel 1, dispensing cap 2, plunger 3, and key 9 may be preferentially molded from materials such as polypropylene, high-density polyethylene or other injection moldable polymers. Due to its shape, key 9 may alternatively be cut or stamped from a variety of sheet materials. Sealing cap 4 may be preferentially molded from polyisoprene rubber or other thermoplastic elastomers. Material selection for all syringe components in embodiments will generally depend upon cost and chemical compatibility considerations. The basic functionality of inventive concepts disclosed can be adapted to many different material choices.

The typical assembly sequence of syringe 100 starts with snapping stop key 9 onto the plunger 3, placing the plunger base 6 on a flat surface with the proximal sealing end oriented upwards, pushing barrel 1 down over the sealing cap 4 until it is stopped by the key 9. At this time, the partial assembly is reading for filling the barrel 1 with material in preparation for dispensing and potentially mixing. After the material is prepared for dispensing, dispensing cap 2 is placed over the open top of the barrel. Dispensing cap 2 illustrated has a nozzle 8 with a dispensing orifice 17 at the proximal end. Finger tabs 7 on the dispensing cap 2 may be included so that the plunger 3 may be moved in the proximal direction relative to both the barrel 1 and the dispensing cap 2 to dispense material. Although nozzle 8 is shown as a straight nozzle that is integrally formed with the dispensing cap 2, curved or other shapes and sizes are possible. In addition, the dispensing cap 2 could include provisions for different attachment interfaces such as Luer-lock or threaded or other engagements for separable dispensing tips or needles.

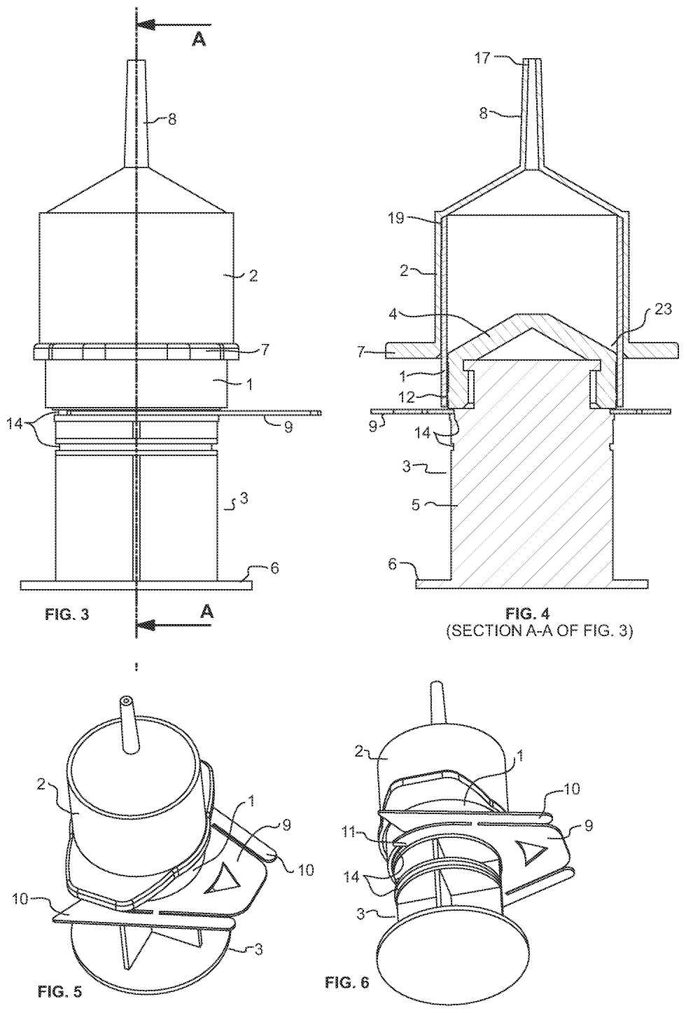

FIGS. 3-6 show the assembled syringe 100 in more detail. For clarity, no material for dispensing has been added to the syringe in these figures. The cross-sectional view of FIG. 4 will be used to describe the interfacing portions of the assembled elements. With key 9 snapped into the upper of the two grooves 14 illustrated, this figure shows how barrel 1 is prevented from moving downward to base 6. When key 9 is removed, barrel 1 is able to move down over the plunger body 5. This is equivalent to the more familiar perspective of a syringe plunger moving inside a barrel towards the nozzle in the proximal direction to dispense material. With the key 9 stopping relative movement, a processing chamber is formed in the interior space bounded by the sealing cap 4 acting as the bottom and the portion of the bore 20 of the barrel 1 located above the sealing cap 4 to the proximal end of the barrel 1. Since the position of the sealing cap 4 to the barrel 1 is known through the location of the key 9, the volume of the processing chamber at any vertical distance in the processing chamber can be calculated from the size and shape of the interior. Inserting key 9 into the lower groove 14 in FIG. 4 would stop the barrel 1 closer to base 6, thereby reducing the volume of the processing chamber. Graduations 16 may be added to the barrel to provide information on the amount of material added to the processing chamber or changes in the amount of material dispensed. FIG. 4 shows how sealing cap 4 makes an interference fit with the bore 20 of the barrel. In this figure, the shallow convex proximal end shape of the sealing cap as illustrated conforms to the interior tapering 22 of the dispensing cap 2. While matching these shapes will help dispense all of the material from the syringe barrel, it does create a tapered channel 23 at interface of the bore 20 and sealing cap 4 of the processing chamber. This channel 23 may increase the difficulty in mixing materials near the sealing cap 4; that is, at the bottom of the mixing chamber. Using a flat or concave proximal end shape of the sealing cap (not illustrated may improve manual mixing ease at the expense of additional wasted material left in the barrel when the plunger contacts the inside of the dispensing cap. For these reasons, if concave or convex shapes are used, it is preferred that they are shallow concave or shallow convex surfaces. A sealing cap that changes shape from flat or concave to convex through buckling could be employed but will not be preferred in many cases due to the additional complexity.

In FIG. 4, the distal portion of the dispensing cap 2 is shown as making an interference fit with the exterior of the barrel 1 from the internal taper 22 leading to the nozzle to the distal end proximate the finger tabs 7. The proximal end of barrel 1 illustrated includes a chamfer at sealing region 19 to make it easier to slide the dispensing cap 2 over the barrel 1. The degree of sealing necessary in this region will depend upon the viscosity of the material to be dispensed, the sizes of the bore 20 and nozzle orifice 17 and material properties and tolerances of the components. For a simple interference fit, sealing region 19 near the proximal end of the barrel 1 is most important. Compared to water, the resistance to flow of more viscous materials helps with sealing in this region since by Poiseuille's law for resistance, viscous flow through small orifices is hindered. The act of dispensing by pushing the plunger base 6 inside the bore 20 toward the finger tabs helps hold the proximal end of the barrel against the inside of the dispensing cap in the sealing region 19 even in the absence of a tight interference fit at sealing region 19. Material that leaks to fill in any mismatch between the exterior of the barrel and distal bore of the dispensing cap will increase the resistance to further flow. When a simple interference fit is not sufficient to contain the dispensed material at sealing region 19 in a particular application, additional sealing features such as O-rings, snap fits or threaded connections may be employed. In order to facilitate filling and mixing, it is preferable that these sealing features are incorporated on the outside of barrel 1 so that the bore 20 at the proximal end of the barrel is not reduced in size.

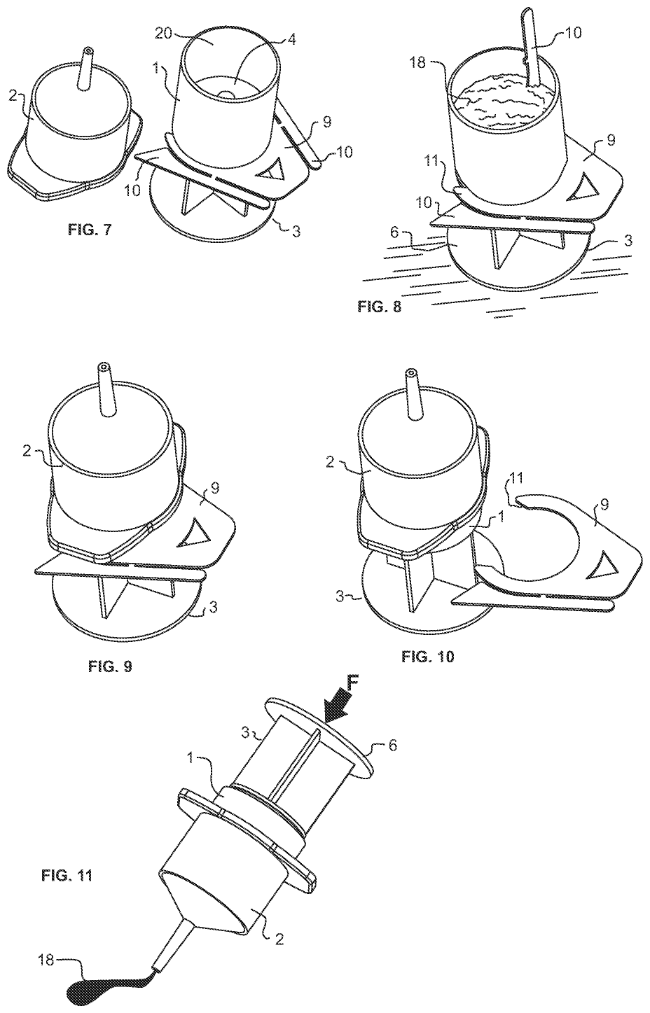

FIGS. 7-11 illustrate the process of using the syringe for mixing and dispensing. FIG. 7 shows the assembly of FIG. 3 with the dispensing cap 2 removed and placed beside the assembly of the barrel 1, plunger 3 and key 9. Stirring paddles 10 are shown on both sides of key 9. These may be molded as part of key 9 and detached from central key portion 13 through fatigue flexing. One end of the stirring paddle may be shaped to approximate the shape of any tapered channel 23 in the processing chamber. FIG. 4. shows the cup-like processing chamber that is formed by bore 20 of the barrel with the bottom of the chamber formed by the sealing cap 4 of the plunger 3. Note that the processing chamber illustrated is quite stubby having a depth along the longitudinal axis that is less than the diameter of the bore 20. Stubby processing chambers are preferred for ease of filling and ease of manual mixing with the configuration shown in FIGS. 7 and 8. For a processing chamber volume in the range of 5 to 30 ml, a bore diameter of about 1. 2 cm to 3 cm is easy to use and provides good visibility of the materials during mixing. Squat processing chambers may be preferred for larger volumes to better fit the hand. By having multiple selectable stop 14 options built into the plunger as shown in FIG. 4, the volume of the processing chamber can be adjusted by the user as desired to make the mixing chamber more stout for easier mixing. A minimum bore diameter of one centimeter is preferred for ease of manual mixing.

FIG. 8 illustrates the manual mixing process after adding mixture 18 to the processing chamber of FIG. 7. When mixture 18 is determined to be adequately mixed, dispensing cap 2 is placed on top of this processing chamber as shown in FIG. 9 and may be pushed down to create the interference fit between the barrel 1 and the dispensing cap 2. To retain mixed material that is sticking to the stirring paddle 10, the user will naturally scrape the paddle clean using the open end of barrel 1. Some mixed material may be transferred to the top edge or on the outside of barrel 1 as a result. The extended overlapping length of the dispensing cap 2 over the barrel 1 helps isolate this material from the user's fingers more than would be possible with a shorter snap-on or threaded attachment. In addition, the distal end of the dispensing cap can be modified to include a space to capture this excess material as the dispensing cap is positioned, if desired. Additional isolation can be provided by extending the finger tabs 7 further. The typically higher viscosity of the hardening mixtures generally prevents contamination of the plunger base 6. In FIG. 10, key 9 is removed to allow movement of the plunger 3 in the barrel 1 to dispense material 18. At this point, air at the proximal end of the barrel and dispensing cap may be removed by moving plunger 3 towards nozzle 8. With mixtures that flow slowly under the force of gravity, maintaining the nozzle up to expel air after mixing and before dispensing material may not be necessary. As shown in FIG. 11, applying a force to the base 6 of the plunger 3 while holding the dispensing cap 2 with the finger tabs to move the plunger towards the nozzle dispenses material where desired. After dispensing, the syringe would generally be discarded.

The sequence described and illustrated with FIGS. 7-11 assumed that the syringe 100 was supplied empty in FIG. 7. Of course, it is possible to pre-fill the syringe with one part of a two-part hardening system so that one part would be contained in the barrel 1 in preparation for mixing in FIG. 8. As described above, the stop 14 and key 9 may include a locking feature that prevents relative motion between the barrel 1 and plunger 3 in both directions. For a powder-liquid mixture such as some acrylic systems, it is preferable to prefill the barrel 1 with a known quantity of the powder component and supply the appropriate amount of liquid catalyst in a sealed cup, pouch or bottle to pour into the barrel in preparation for mixing. The powder component in this case could be kept in barrel 1 using a foil or other laminar seal or a cap or plug blocking the proximal end of the barrel. Other options are available when the desired quantity of reactive mixture is prescribed. For example (not illustrated), both components could be stored in the barrel by the manufacturer but separated to prevent reacting until needed. The powder could be loose in the barrel and the liquid contained in a flexible pouch. The pouch could be punctured with a pointed end of a stirring stick for manual mixing. If the distal end of the pouch is fixed to the distal end of the barrel, the plunger could be used to squeeze the liquid from the pouch as it pushes the powder and liquid in the proximal direction. Pushing the plunger past the proximal end of the pouch and inserting the key would provide the powder and liquid ready for mixing as in FIG. 8. For many applications, this complexity is not necessary.

Various embodiments have been described to illustrate the disclosed inventive concepts, not to limit the invention. There may be benefit in employing some inventive concepts individually or in different combinations than described above. The embodiments described should not be interpreted as limiting. Combining inventive elements of one or more of the embodiments with known materials, components and techniques to create further embodiments using the inventive concepts is considered to be part of this disclosure. Although the discussion above details the benefits of using the embodiments for both mixing and dispensing of two-part hardening mixtures, other uses and applications are possible and are considered to be part of the scope of this disclosure. For example, it may be desirable to accurately dispense a one-part viscous material that is not typically supplied in a small syringe. One feature of the embodiments described above is the ease of filling them with the material to be dispensed in the field. For example, the one-part material can be dispensed at the point of use from a caulking gun tube or otherwise transferred into one of the embodiments above against the plunger. While this could be done by dispensing it into a conventional syringe with the plunger removed, the problem of entrapped air would remain with a conventional syringe. The relatively wide barrel of the disclosed embodiments make transfer easier with a paddle or spatula than the relatively narrow barrels of small volume conventional syringes. Although the embodiments above describe mixing chemically reactive components to form a hardening mixture, the embodiments may also be used with single-part hardening systems. One example of such a system would be a material that has relatively viscous flow at an elevated temperature but stops flowing when it cools below a threshold temperature. While manual dispensing using one hand to move a plunger relative to a nozzle are described, inventive concepts may be applied to systems that do not use a human hand to move a plunger for dispensing. These types of adaptations are not excluded and are considered to be disclosed herein and within the scope of claims that may be broadly interpreted to apply to them.

1. A syringe for dispensing a viscous material comprising:
a plunger comprising:
a proximal end comprising a sealing structure portion,
a distal end comprising a base portion, and
a body portion located between the sealing structure portion and the base portion, and
a barrel comprising a bore, wherein the bore is sized for sealing with the sealing structure of the plunger, and wherein inserting the plunger into the distal end of the barrel forms a processing chamber for receiving material to be dispensed,
a dispensing cap, wherein the dispensing cap comprises:
a proximal end with a nozzle, and
a distal end with an orifice sized to allow the proximal end of the barrel to be inserted, and wherein inserting the proximal end of the barrel into the dispensing cap and moving the plunger base toward the nozzle causes material contained in the processing chamber to be dispensed through the nozzle.

2. The syringe of claim 1 wherein the bore at the distal end of the barrel is cylindrical and has a diameter that is at least comparable to the height of the processing chamber.

3. The syringe of claim 1 wherein the base of the plunger supports the processing chamber with the proximal end of the barrel upward.

4. The syringe of claim 1 wherein the syringe comprises a means for stopping motion of the barrel relative to the plunger in at least one direction.

5. The syringe of claim 4 wherein the syringe comprises a plurality of relative stopping positions of the barrel relative to the plunger for selecting the volume of the processing chamber.

6. The syringe of claim 4 wherein the means for stopping motion of the barrel relative to the plunger in at least one direction comprises a key that is attached to the plunger that limits the motion of the plunger relative to the barrel in the proximal direction.

7. The syringe of claim 1 wherein two materials are manually mixed in the processing chamber to form a reactive hardening material.

8. The syringe of claim 7 wherein the syringe is supplied to the user with one material stored in the processing chamber with a seal over the proximal end of the processing chamber.

9. The syringe of claim 1 wherein the dispensing cap is sealed to the barrel with an interference fit.

10. The syringe of claim 9 wherein the barrel is inserted inside the distal end orifice of the dispensing cap a distance sufficient to prevent material leaking through the interference fit sufficient to extend beyond the distal end of the dispensing cap after the plunger is moved to dispense material through the nozzle.

11. The syringe of claim 9 wherein the compressive force between the plunger and dispensing cap during dispensing material reinforces the sealing of the barrel to the dispensing cap.

12. A mixing and dispensing syringe for viscous materials comprising:
a barrel having a longitudinal axis, a proximal end and a distal end, the barrel comprising:
a barrel bore having an orifice on the proximal end of the barrel, and
a sealing member capable of moving along the longitudinal axis of the bore towards the orifice, and wherein the sealing member and the bore form a mixing chamber, and wherein the orifice forms the open top of the mixing chamber configured for manual mixing reactive materials with a stirring paddle through the orifice, and
a dispensing cap comprising:
a nozzle on the proximal end, and
a bore for receiving the barrel on the distal end
wherein the dispensing cap is placed over the open top of the mixing chamber when the reactive mixture is ready for dispensing and moved longitudinally to form a seal with the barrel and wherein moving the sealing member towards the nozzle pushes the reactive mixture through the nozzle.

13. The mixing and dispensing syringe for viscous materials of claim 12 further comprising a laminar seal and wherein at least one of the reactive materials is supplied inside the barrel and wherein the laminar seal is removed by the user prior to mixing.

14. The mixing and dispensing syringe for viscous materials of claim 12 further comprising:
a plunger connected to the sealing member, wherein the plunger comprises:
a base portion wherein the base portion orients the longitudinal axis of the barrel with the orifice facing up, and
a body portion connecting the base portion to the sealing member, wherein the body portion comprises a key receptacle, and
a key wherein the key comprises:
a removable mechanical interface with the key receptacle capable of preventing motion of the sealing member toward the orifice.

15. The mixing and dispensing syringe for viscous materials of claim 14 wherein the orifice has a width that is larger than about 1 cm, and wherein the longitudinal distance between the proximal end of the barrel and the proximal end of the sealing member is not more than two times the width of the orifice.

16. The mixing and dispensing syringe for viscous materials of claim 15 wherein the width of the base is greater than the width of the orifice.

17. A mixing and dispensing syringe for reactive materials comprising:
a squat cylindrical chamber comprising a side wall in the form of a circular bore and a bottom with an outer edge a sealing relationship with the side wall wherein the bottom can be moved along the longitudinal axis of the cylinder to change the volume of the chamber and wherein the top of the chamber has an orifice having a width essentially equal to the diameter of the circular bore;
a stop means for temporarily holding the volume of the chamber constant during the mixing of reactive materials wherein a stirrer is manipulated through the orifice to mix the reactive materials;
a dispensing cap comprising:
a nozzle, and
a bore sized to accept the chamber to form an interference fit with the top of the chamber, and wherein the bore is shaped to provide a path for mixed material to flow from the chamber through nozzle after removing the stop means and moving the bottom of the chamber towards the nozzle.

18. The mixing and dispensing syringe for reactive materials of claim 17 wherein the chamber bottom does not deviate from a flat surface in the longitudinal direction by more than ⅓ of the circular bore diameter.

19. The mixing and dispensing syringe for reactive materials of claim 17 wherein the mixed material at the top of the chamber near the axis is moved through the nozzle at the beginning of the dispensing process.

20. The mixing and dispensing syringe for reactive materials of claim 17 wherein the chamber has a length along the longitudinal axis that is less than twice the diameter of the circular bore.
